(19) United States
(12) Patent Application Publication
(10) Pub. No.: US 2016/0249412 A1
(43) Pub. Date: Aug. 25, 2016

(54) HIGH-TEMPERATURE NANOCOMPOSITE EMITTING FILM, METHOD FOR FABRICATING THE SAME AND ITS APPLICATION

(71) Applicants: Igor Romanov, Minsk (BY); NOVAIR, INC., Tucson, AZ (US)

(72) Inventors: Igor Romanov, Minsk (BY); Alexandr Kropachev, Tuscon, AZ (US); Terje Skotheim, Tucson, AZ (US)

(21) Appl. No.: 14/783,071

(22) PCT Filed: Apr. 8, 2014
(86) PCT No.: PCT/US14/33381

§ 371 Date: Nov. 24, 2015

Related U.S. Application Data
(60) Provisional application No. 61/853,607, filed on Apr. 9, 2013.

(51) Int. Cl. H05B 3/14; H05B 3/22

(52) U.S. Cl. CPC H05B 3/14; H05B 3/22; H05B 2203/032; H05B 2214/04

(57) ABSTRACT

An inventive thin-film radiative structure is provided that includes a thin nanocomposite radiative film deposited on a substrate, the thin-film including a mix of finely dispersed phases formed by elements Mo, Si, C, O in the following atomic percentage terms: Mo from 10 to 20%, Si from 15 to 30%, C from 15 to 60%, O from 0 to 20%, and one or a combination of elements Ti, Zr, Hf, Cr, Si, Al, and B in percentage terms of 0-30%. The thin-film radiative structure has an emissivity of more than 0.7 for wavelengths 2-20 μm at temperatures above 500° C., and a sheet resistance of between 10 and 150 Ohm/sq. The radiative film may be used as a thermoresistive element in thin-film infra-red thermal emitters and infra-red heaters, and in nondispersive infrared sensors (NDIR) and photo-acoustic gas sensors, and as the radiative element in IR signaling devices.

### RELATED APPLICATIONS

This application claims priority benefit of U.S. Provisional Application Ser. No. 61/853,607 filed Apr. 9, 2013; the contents of which are hereby incorporated by reference in their entirety.

### FIELD OF THE INVENTION

The present invention in general relates to high-temperature resistant composites and methods of fabrication, and in particular to inorganic nanocomposite thin films capable of emitting thermal energy in the infrared wavelength region as a result of resistive heating.

### BACKGROUND OF THE INVENTION

Micromachined thin film thermal infrared emitters (IRE) play an important role in the development of highly accurate chemical sensors, and serve as the principal infrared emitting elements in optical gas sensor systems. The application of the infrared (IR) emitting membrane as a pulsed light source in IR absorption gas sensors typically requires thin-film resistors with a sheet (surface) resistance in the range of R_{S}=10-150 Ohm/□ (Ohm/square) with an accuracy of not less than ±5%. Other applications include as the IR radiating element in IR signaling devices, typically referred to as IR beacons.

Industrial production of IRE involves the formation of microstructures on a silicon (Si) wafer, and typically several hundred devices are processed simultaneously. The nanocomposite emitting film is deposited with chemical vapor deposition (CVD) or physical vapor deposition (PVD) methods. The specific features of the thin film IRE structure and the method of fabrication impose additional restrictions on materials and method for fabricating the thin film resistor.

The basic criterion of material selection for usage as a thermoresistive medium in IRE is the emission of IR light energy radiated by the material when heated, which is determined as emission power. The radiation emitted per unit surface area is:

E=∈·σ·T⁴ (1)

where ∈ is the emissivity of the surface; σ=5.67·10⁻⁸[W·m⁻²·K⁻⁴] is the Stephan-Boltzmann constant; and T is the temperature of the surface in ° K. In practice, when producing high efficiency thin film infrared emitters the most attractive materials are those that have high-temperature stability to T=700-800° C. or higher and with emissivity close to 1.

Among inorganic compounds with the parameters of the equation (1), some compounds of refractory and group VIII metals Mo, W, Ti, etc. may be defined, e.g., silicides of molybdenum and tungsten (MoSi₂ and WSi₂) and silicon carbide (SiC). These materials show very high thermal stability when heating to temperatures in the range of 1700-2000° C. The data quoted by Pears in: Progress in International Research on Thermodynamic and Transport Properties (Ed. F. F. Masi and D. H. Tsai. N.Y., Academic Press, 1962, p. 588), demonstrate high values of emissivity ∈ for several of these materials. For example, for sintered powder of MoSi₂ the integrated value in the infra-red wavelength region is approximately 0.8. According to data provided by Olson O. H. and Morris J. in Handbook of Thermophysical Properties of Solid Materials (Ed. A. Goldsmith et al. N. Y., Pergamon Press, 1961 v. 3, p. 931) the emissivity for powdered SiC is approximately 0.85.

Refractory compounds such as boride metals possess emissivity ∈, close to 1.0. In particular, borides ZrB₂, HfB₂ have matter emissivity that is equal to 0.89. The aforementioned emissivity data is provided by the Handbook of Refractory Compounds (Authors G. V. Samsonov, I. M. Vinitskii, Plenum, New York, 1980). Also according to this handbook, refractory metals such as boride have a high fusion temperature and accordingly, high durability at high temperatures, compared to silicon based compounds such as MoSi₂, SiC. Temperature fusion for ZrB₂ is 3000° C., and for HfB₂ is 3200° C. However, these borides are very fragile, and therefore limits the use of borides in a pure state. However, borides possess value as an additive to other refractory compounds and alloys.

The aforementioned data characteristics serve as a basis for several patents on high-temperature devices where silicides of molybdenum and tungsten or mixtures of both are used. These devices are: thermal resistors (G.B. Pat. No. 828123), resistive infrared heaters (U.S. Pat. No. 3,681,737), infrared emitters (U.S. Pat. No. 7,038,227). The resistive heaters made of silicon carbide SiC (G.B. Pat. No. 1,423,136) are also known. Furthermore, in Japanese patent JP10208854, a composite material MoSi₂—SiC as a material for a resistive heater is described. In U.S. Pat. No. 6,589,898 and U.S. Pat. No. 6,770,856 for manufacturing of infrared heaters, complex composite materials are used which contain a mixture of refractory and group VIII metals [(Mo, W) 5Si₂ and/or (Mo, W) 5SiC] (15/85) %+SiC (2/85) %+(Mo, W) Si₂ (0.8/55) %. In patent GB943054 for manufacturing of a resistive tubular heater composite, MoSi₂ and SiC with additives borides of metals Zr, Hf, V, Nb, Ta, Cr, Mo are used.

All thermal devices listed in the aforementioned patents have been produced from a hot-pressed powdered mixture of initial materials. The products produced are bulk samples. Because of the large dimensions and weight these thermal devices cannot be used for manufacturing of resistive thin film infrared emitters, as the resistor must rest on a thin (approximately 1 micron thickness) freely suspended fragile membrane.

Methods of production for these coatings from the aforementioned materials have been further advanced in other industrial sectors which are distinct from thermal infrared emitters. These branches of industrial sectors include a) space and aviation science of materials, b) protective coatings on samples of group VIII and refractory metals, and c) integrated circuits. U.S. Pat. No. 5,569,427 describes thermal protection systems for aerospace and hypersonic aircrafts that is provided with a coating applied to a porous substrate, for example fibrous ceramic material. The coating includes MoSi₂, SiC, Al₂O₃, SiO₂, and an organic solvent mixture. The coating is applied in the form of liquid paste. The dried coating can resist heating to 1500° C., and has emissivity of not less than 0.8. However, this method of production cannot be used for emitter production, since the thickness of the layer is from 50 to 100 micron compared with the required membrane thickness of approximately 1 micron. In addition, the membrane cannot withstand the pressure of the paste. In the process of paste drying, the coating suffers from a compressive stress that may cause the shrinkage and distortion of the membrane. Furthermore, the surface of the dried coating becomes rough and results in breakage of the protective layers.

There are many patents in which high-temperature coatings are applied with a jet plasma method in vacuum or in an atmosphere, such as vacuum plasma spray (VPS). The VPS method provides flat metal and volume surfaces with considerable strengthening and corrosion protection. In patent EP1428900 A1, a deposited layer of SiC together with a metal boride, such as ZrB₂, TiB₂ and/or HfB₂ is used to provide the protective coating. The use of metal boride prevents the decomposition of silicon carbide during superheating of plasma sputtering, thereby preserving the useful qualities of silicon carbide.

Recently, the development of methods for fabricating films from refractory and group VIII metal silicides, for example MoSi₂, in integrated circuit technology has advanced rapidly. S. P. Murarka in “Silicides for VLSI Applications” (Academic Press, New York, 1993. p. 200) describes methods for producing such films including vacuum evaporation, magnetron sputtering, and CVD techniques. These methods are either co-depositing a metal (e.g., Mo) and silicon mixture in the desired composition from two separate sources followed by annealing at higher temperatures and synthesis of MoSi₂ film, or by magnetron sputtering from a cold-pressed vacuum-sintered composite MoSi₂ target.

As Murarka describes in his book, the methods mentioned above have been used for deposition of films of thickness 0.1-1 microns which are applied for integrated circuit (IC) production to operate at temperatures below 500° C. However, thin MoSi₂ films are not applicable for use in high-temperature emitting devices of the structure shown in FIG. 1. The factor constraining such application of these films is the so-called “MoSi₂ pest reaction”, a phenomenon peculiar to this inorganic composition, resulting in disintegration of MoSi₂ into powdery products. The phenomenon of the “MoSi₂ pest reaction” is described, for example, by Chou T. C. and Nieh T. G. in the article “Pest disintegration of thin MoSi₂ films by oxidation at 500° C.”, Journal of Materials Science 29 (1994), 2963-2967. Low-temperature heating of MoSi₂ films in air (up to 450-500° C.) starts the process of oxidation. As a result, powdery products are formed and they contain MoO₃ whiskers which destroy the film. The “MoSi₂ pest reaction” effect is less pronounced in bulk materials. If a bulk material is rapidly heated up to 1500° C., the MoSi₂ surface becomes passivated with a hard SiO₂ layer and the effect of the “MoSi₂ pest reaction” slows down. A SiO₂ layer formed on the surface of the thin MoSi₂ film during the surface heating in air is not stable because this layer is rather thick and porous. After prolonged heating, the MoSi₂ film is completely transformed into powdered MoO₃. Therefore, pure (impurities-free) thin MoSi₂ films are not applicable in high-temperature emitting devices.

In U.S. Pat. No. 6,200,691 in order to reduce the “MoSi₂ pest” effect in a sputtering target of MoSi₂, the impurity of silicon carbide, SiC, is added. Films are formed by vacuum magnetron plasma sputtering of the target MoSi₂+X SiC in an argon atmosphere. The films are deposited on metal products (Ta, Nb, etc.) to protect the metals from oxidation at high-temperature heating of these products. It is reported that a layer deposited in pure Argon is structurally (thermally) stable and chemically resistant at temperatures up to 1000° C., and with sputtering in the atmosphere of (Ar+N₂) gas mixture the layers are stable at 1260° C.

Furthermore, it is also known that some compositions of transitive and refractory metals, in particular silicides of molybdenum and silicon carbide, possess a high value of emissivity and thermal resistance for a bulk material. However, application of these materials in the form of pure (without additional impurity) thin films in infrared emitters presents difficulties. Films of MoSi₂ under high-temperature heating lose their resistance because of oxidation of the top layer. SiC resistivity is of great importance, but does not provide the possibility of the creation of thin-film IRE with a low value of sheet resistance for a heating element based on this material.

While the method of production of thin films of MoSi₂, SiC and their mixtures which can be applied to fabrication of thin-film IRE is known, where the method consists of magnetron ionic-plasma sputtering in a high vacuum in the proximity of an inert gas Ar of an initial bulk material. However, there is currently no data as to the technological parameters of this method, and in particular, the composition of a source substance, conditions of formation, and the composition of films with optimal emissivity and thermal stability properties. There is also no information about the parameters of this method, that are required for depositing thin resistive films in the range of resistance which is required for application to IRE in optical gas sensors. Thus, there exists a need for a method for depositing thin resistive films with high thermal stability in the range of resistance which is required for application of IRE in sensors, such as optical gas sensors, and as infrared emitters in IR signaling devices.

### SUMMARY OF THE INVENTION

An inventive thin-film radiative structure is provided that includes: a thin nanocomposite radiative film deposited on a substrate, the thin-film including a mix of finely-dispersed phases formed by elements selected from the group consisting of: Mo, Si, C, O that exist in the following atomic percentage terms: Mo from 10 to 20%, Si from 15 to 30%, C from 15 to 60%, 0 from 0 to 20%, and one or a combination of elements selected from the group consisting of: Ti, Zr, Hf, Cr, Si, Al, and B in atomic percentage terms of 0-30%. The thin-film radiative structure has an emissivity of 0.7 or higher for wavelengths 2-20 μm at temperatures above 500° C., and a sheet resistance of between 10 and 150 Ohm/sq. The substrate is one of a low stress membrane, a membrane with low tensile or compressive stress, silicon nitride, and ceramic. In specific embodiments the thin nanocomposite radiative film has a thickness of 0.1-2.0 μm. Embodiments of the inventive thin nanocomposites radiative film may be used as a thermoresistive element in thin-film infra-red thermal emitters and infra-red heaters, and in nondispersive infrared sensors (NDIR) and photo-acoustic gas sensors and the radiative element in IR signaling devices.

### BRIEF DESCRIPTION OF THE DRAWINGS

The present invention is further detailed with respect to the following non-limiting specific embodiments of the present invention. The appended claims should not be construed as being limited to the specific devices so detailed.

FIGS. 1A-1B are cross-sectional side and top views that depict the basic thin-film structure of an infrared emitter (IRE) chip;

FIG. 2 is a graph of resistance as a function of background oxygen pressure inside a vacuum chamber for film deposition, and illustrates the dependence of sheet resistance of the films received by sputtering of a target: MoSi₂+35 mole % SiC in a partial pressure of oxygen P_{oxygen}.

FIG. 3 is a graph of microanalysis results from an energy-dispersive X-ray spectroscopy (EDAX) of the films produced by sputtering of a target with a (MoSi₂+35 mole % SiC) composition.

### DESCRIPTION OF THE INVENTION

The present invention has utility as a method for forming devices with inventive forms of inorganic nanocomposite thin films that are capable of emitting large amounts of thermal energy in the infrared wavelength region as a result of resistive heating. In certain embodiments, the fabrication of inventive thin films is by sputtering in a high vacuum of a mix of various refractory materials consisting of MoSi₂, SiC and/or oxides of various metals, e.g., Si, Ti, Zr, Al, B and/or boride metals, e.g., TiB₂, ZrB₂, HfB₂, CrB₂, SiB₄, SiB₆, CB₂ and/or carbide metals, e.g., TiC, ZrC, HfC.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, high-temperature stability is defined as compositional retention to at least 500° C., and up to 900° C., and an emissivity of at least 0.7 for wavelengths 2-20 μm.

Unless otherwise stated herein, compositional percentages are provided in atomic percentages of a total composition for separate chemical elements and in molecular percent (mole %) for chemical compounds.

Embodiments of the present invention relate to a new class of nanocomposite materials suitable as thermoresistive material in Miro-Electro-Mechanical-Systems (MEMS) devices for infrared light emission and heating. The infrared emitting light sources can emit light in the range of 1-20 micrometers and can pulse up to 100 Hz and are suitable as light sources in IR gas sensors and infrared signalling devices. A suitable thickness of the nanocomposite thermoresistive film as an infrared light source is in the range 0.05-1.0 microns. The nanocomposite materials include a mixture of finely dispersed phases of materials formed of the chemical elements Mo, Si, C, O and Me, where Me is one of the metallic elements Ti, Zr, Al, B, or their combinations. Films of the nanocomposite material are produced using vacuum magnetron sputtering in an atmosphere of pure Ar from a target including MoSi₂+(10-85) mole % SiC+(0-30)% Y, where Y is selected from the metal-oxides SiO₂, TiO₂, ZrO₂, Al₂O₃, B₂O₃. Films can also be made by magnetron sputtering from a target including MoSi₂+(10-85 mole %) SiC in an atmosphere of a gas mixture consisting of Ar+O₂. The second variant of inventive films is produced by magnetron sputtering of target MoSi₂+(1-100) mole % SiC+(0-60) mole % Z where Z gets out of a number borides: TiB₂, ZrB₂, HfB₂, CrB₂, SiB₄, SiB₆, CB₂, or their combinations. The third variant of inventive films is produced by magnetron sputtering of target MoSi₂+(1-100) mole % SiC+(0-60) mole % W. Films have a total emissivity equal to 0.8 in the infrared spectrum at temperatures of 700° C. 800° C. The range of compositions as atomic percentage of the elements which include the nanocomposite films, as well as the range of weight percentage ratios of the components constituting the sputtering target are defined. Also defined is the range of pressure of oxygen at which the films have optimum value of sheet resistance in a range 10÷150 Ohm/□.

The novel thin-film infrared emitting materials form the active, emitting element in infrared light sources. The inventive infrared light sources have a multitude of applications, including, but not limited to nondispersive infrared sensor (NDIR) gas sensors.

Embodiments of the invention leverage known properties including:

The atomic percentage ratio of the elements which are a part thin nanocomposite films produced by sputtering in a vacuum of a bulk material in the form of a mixture of MoSi₂ and SiC have integral emissivity ∈ of approximately 0.8 in the infrared spectrum at a temperature of 700-800° C., and a sheet resistance Rₛ=10÷150 Ohm/□ (Ohm/square) with an accuracy of not less than ±5%.

The introduction in a structure of an initial mixture of metal oxides from the following: SiO₂, TiO₂, ZrO₂, Al₂O₃, B₂O₃ to the films improves the film's ability to stably operate as an IR emitter with a frequency range of up to 100 Hz.

The introduction in a structure of an initial mix of borides, refractory and other metals—ZrB₂, HfB₂, CrB₂, SiB₄, SiB₆, CB₂, where the introduction of these additives increases the lifetime performance of radiating and heating devices.

The introduction in a structure of an initial mix of carbides and refractory metals TiC, ZrC, HfC, where these additives increases lifetime performance of radiating and heating devices. These properties are achieved with vacuum magnetron sputtering of source materials in inert gas of Ar, or a gas mixture of Ar and O₂.

The inventive thin-films have a high total emissivity ∈ of typically 0.8 in the infra-red region of the spectrum, as measured with the thin-films deposited on a ceramic substrate. The same ceramic substrate covered with soot was used as a comparison, where the emissivity ∈ was considered equal to 1. The long term high thermal stability of the thin-films has been experimentally confirmed up to at least 900° C.

The inventive thin-films possess such high values of emissivity ∈ only for certain compositions of the initial sputtering target. If the composition of the initial sputtering target materials is represented by the formula (MoSi₂+X.SiC+Y), then X=mole percentage SiC, Y=mole percentage of metal-oxides from the group Si, Ti, Zr, Al, B or their mixture. The composition will be the following: 85>X (mole %)>10, 30>Y (mole %)>0. If X>85 mole %, the films have sheet resistance Rₛ>150 Ohm/□. The Rₛ of the films increases with increased quantity of SiC. Application of such high-resistivity films in thin-film IRE is undesireable since the films will require a high voltage to operate. A similar effect of an undesirable increase in Rₛ is observed with an increase in the components Y to more than 30 mole %. For X<10 mole %, a decrease in the hardness of the films at high-temperature is observed. This effect is connected with oxidation of the MoSi₂ phase with a low content of the phase SiC, whose presence slows down this negative process.

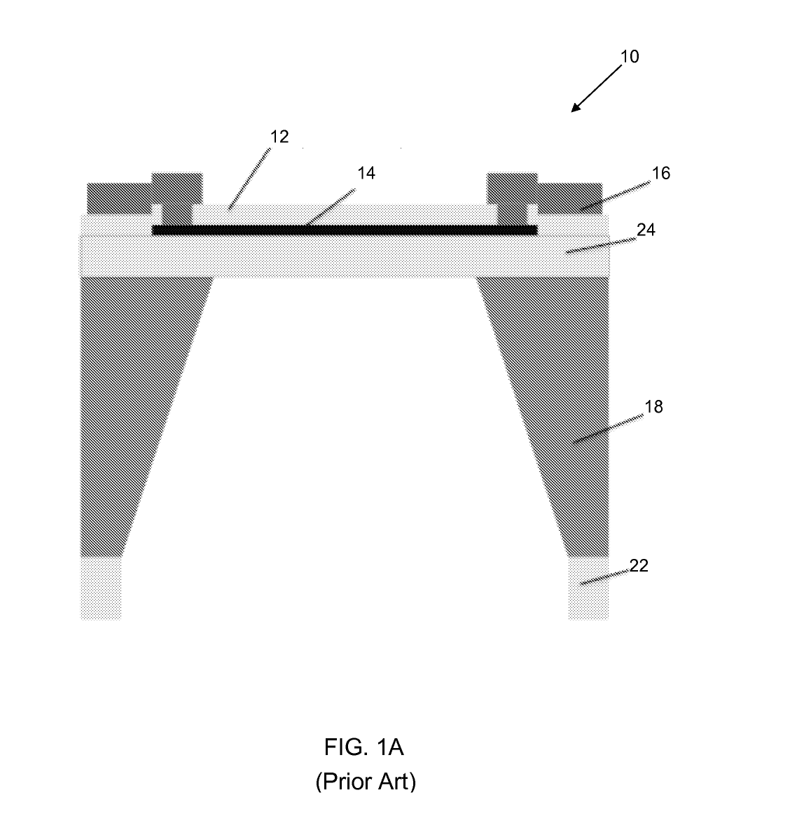

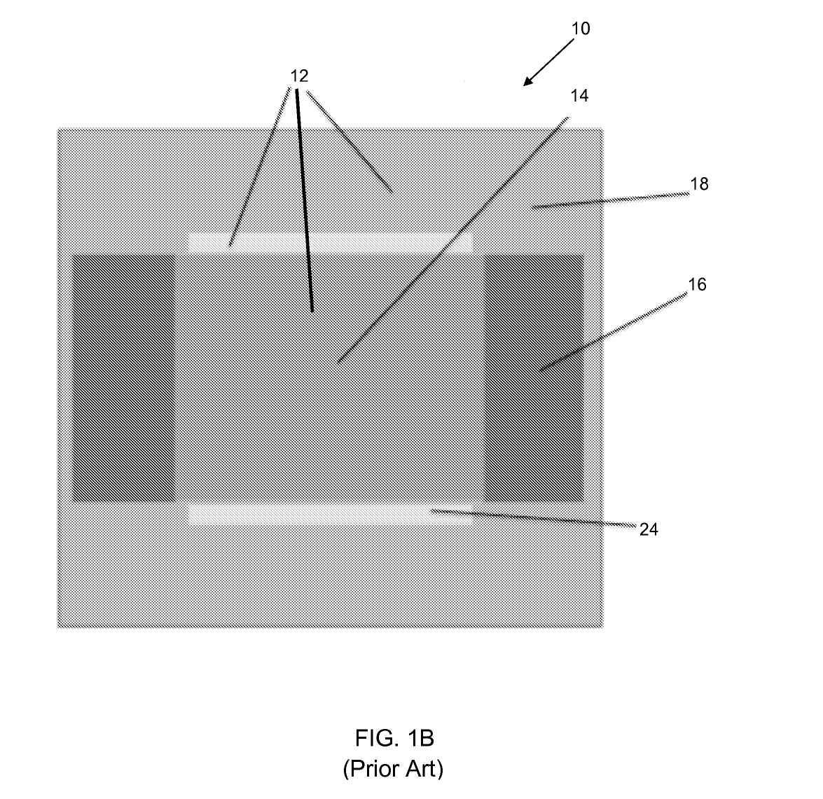

The present invention has utility as a thin-film resistor in thin membrane infra-red emitters (IRE). Such devices are made in the form of thin-film structures. The typical thin-film structure is shown in FIGS. 1A and 1B as used from example as an infrared emitter (IRE).

The basic element of the IRE structure 10 is a thin thermoresisitve film 14 of typical thickness of 0.05-0.4 μm (micro-meters (microns)) that is deposited on top of a thin low stress (typically 50-150 MPa) insulating (dielectric) membrane 24 with a typical thickness of 0.5-1.5 microns. The thin film structure of the infrared emitter 10 is characterized by the following combination of properties: a thin (typically 1.5-2.5 μm) free-hanging multilayer membrane supported by a silicon frame 18 (typically 0.4-0.5 mm thickness); and a thin low-stress (typically 50-150 MPa) dielectric membrane that is used as a substrate 24 for the thermoresistive film 14. The low thermal mass of the membrane coupled with high emissivity, allows the membrane to cycle in temperature with a frequency of 10-50 Hz, and up to 100 Hz.

The membrane or substrate 24 is formed with low-stress, non-stoichiometric silicon nitride (SiN), and includes in some inventive embodiments multilayers or alternating films comprising SiO2, SiN and nanoamorphous carbon that have a typical thickness of individual layers of 0.05-1.0 microns, for a typical combined thickness of 0.5-1.5 microns, if such multilayers are present. This multilayer membrane typically includes a protective topcoat 12 of a dielectric material, typically low-stress SiN, and includes in some inventive embodiments multilayers or alternating films comprising SiN, SiO2 and nanoamorphous carbon, with a typical total topcoat thickness of 0.1-1.0 microns as protection of the thermoresistive film 14 against oxidation. The multilayer membrane is suspended by a silicon frame 18 and produced with microsystems or MEMS (Micro-Electro-Mechanical-Systems) technology by etching the Si from the back of a Si wafer. The silicon wafer is coated on the backside by a film of SiN 22. Reactive Ion Etching (RIE) process was used to open windows in the backside SiN for etching the Si wafer from the backside in order to produce the freehanging multilayer membrane. The thin film thermoresistor 14 may be patterned in such a manner as to have a gap 15 between the thermoresistor and the silicon frame 18 along the edges in order to minimize thermal loss by conduction to the silicon frame 18 as shown in FIG. 1b. The gap 15, which consists of the dielectric support membrane 24 and the topcoat 12 may be 0-400 microns, and is typically 50-300 microns. The thin film thermoresistor 14 in some embodiments has a sheet resistance in the range of Rₛ=10-150 Ohm/□. The thin film thermoresistor 14 is positioned between metal contact pads 16. The method of fabrication of such thin membrane infra-red emitters (IRE) structures is compatible with standard microelectronic methods of fabrication of thin film devices on a substrate with PVD and CVD methods of film deposition. Magnetron sputtering provides for the formation of thin-film structures as shown in FIGS. 1A and 1B without membrane destruction.

In specific embodiments, the sputtering of the films is carried out in an argon atmosphere. Thus, the vacuum is reduced to a pressure 10⁻³ Pa. The sputtering process is conducted with Ar gas introduced into the vacuum chamber to a pressure P=8·10⁻²÷2·10⁻¹ Pa. The sheet resistance of films Rₛ does not depend strongly on the pressure. For a film thickness of 0.5 microns, the films have values in the range of Rₛ˜20-40 Ohm/□ all values P in this range.

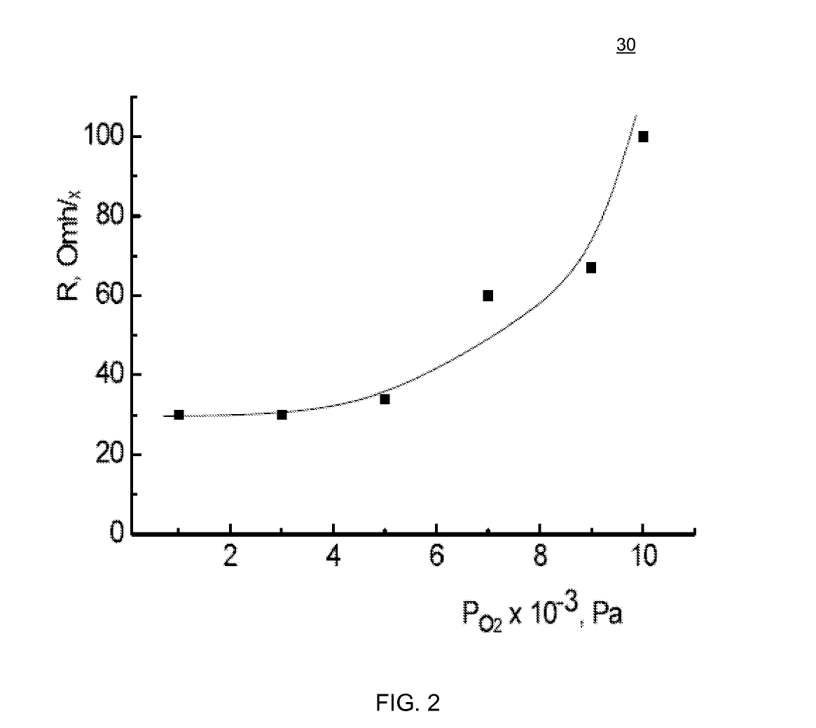

It has surprisingly been discovered that if the sputtering is done in a mixture of argon and oxygen, the sheet resistance of the applied thin-film increases, and the thin-film resistance value depends on the partial pressure of oxygen. In FIG. 2, the dependence of sheet resistance of films produced from a target of MoSi₂+35 mole % SiC in a partial pressure of oxygen (P_{oxygen}) is shown. These tests are carried out for films of an identical thickness of 0.3 microns. For all experiments, the pressure of the gas mixture (Ar+O₂), is equal to 1·10⁻¹ Pa. As shown in FIG. 2, with a change in the partial pressure of oxygen in the range P_{oxygen}=5·10⁻³-1·10⁻² Pa, the sheet resistance varies in the range Rₛ=30-100 Ohm/□. Furthermore, for the films deposited in a partial oxygen atmosphere, the emissivity and thermal stability are measured, and it is shown that these parameters do not deteriorate.

In inventive embodiments, the structure and phase composition of films are defined by the method of film deposition. At a thickness of 0.1-1 micron, the thin-films can be considered as quasi-two-dimensional objects and their properties are in many respects defined by properties of a surface of a substrate and the conditions of film growth. With ion-plasma methods of films deposition, and in particular magnetron sputtering, the target material is sputtered in a vacuum under the influence of high-energy ions of the inert gas (Ar) and deposited on a substrate in the form of a stream of neutral molecules, atoms, and ions. Condensation of this stream on a substrate at room temperature leads to formation of highly dispersed films with a complex multiphase composition and a quasi-amorphous structure. Furthermore, with the size of crystal grains in the nanometer range, the films are effectively a nanocomposite.

An analysis of the atomic-molecular structure of the thin-films described in the present invention was carried out. Electron transmission diffraction patterns of the films made immediately after deposition on a substrate exhibited the presence of two wide rings, characteristic of quasi-amorphous highly dispersed structures with crystal size of 2-5 nanometers. The type of rings and their characteristics demonstrated the presence of a considerable fraction of amorphous phases. Exact electron-diffraction analysis of phases with a size of crystal areas in the range 2-5 nanometers against an amorphous phase is difficult. The stream of a sputtered material contains ions and atoms and neutral molecules. Their condensation on a substrate can lead to formation of new phases.

Consider an example of a target having the following components: MoSi₂, SiC and SiO₂. If in a sputtered material the only phases present are α-MoSi₂ (tetragonal), β-SiC (cubic) and α-SiO₂(trigonal), the formation of other double and threefold phases, in particular, β-MoSi₂ (hexagonal), α-SiC (hexagonal), and Mo₅Si₃ (hexagonal), Mo₂C (hexagonal), Mo₂₄Sil₅C₃, and also complex phases containing oxygen, for example, MoOC, CSiO₂, etc., is possible. Some of these phases can form solid solutions of a nonstoichiometric composition.

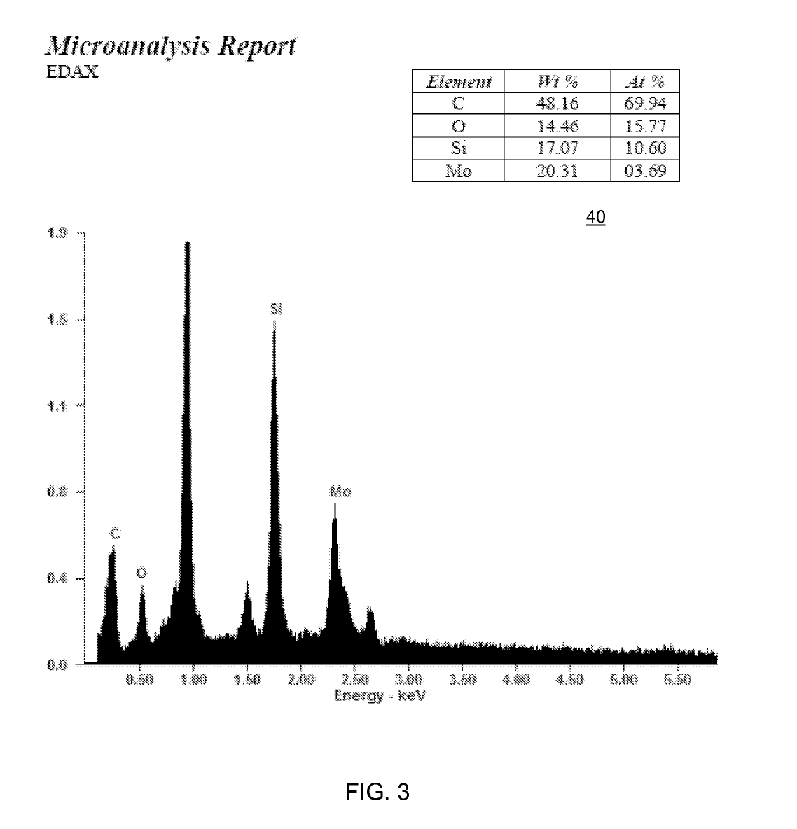

By means of X-ray element analysis EDAX (Genesis 2000 system), the elemental composition and the atomic percentage ratios of elements of the films have been measured. FIG. 3 shows a typical X-ray spectrum measured for a film produced by sputtering of an initial material with composition (MoSi₂+35 mole % SiC) that is carried out in a mix of gases, such as Ar and O₂.

A determination of the dependence of emissivity and thermal stability of films on elemental composition is shown in Table 1 for the ranges of atomic percentages of the elements in the films studied, produced by target sputtering in pure Ar and in a mix of Ar and O₂. The films with such a ratio of elements in their composition have emissivity in the IR-region of the spectrum equal to approximately 0.8 and have a high thermal stability.

TABLE 1

| | |
|---|---|
| Gas filled | |
| into the | At. % ratio of elements in film |

| chamber | Mo | Si | C | O |
|---|---|---|---|---|
| Ar | 5-25 | 10-35 | 30-85 | 0.5-1* |
| Ar + O₂ | 10-20 | 15-30 | 15-60 | 10-20 |

*attached foreign material

Embodiments of the inventive thin film in the form of a nanocomposite radiative film may be fabricated on a substrate while the substrate has an electrical bias applied, where the bias may be in the range of 0-400V. In addition the bias may be applied at a radio frequency (RF), where the RF ranges between 100 KHz-13.6 MHz.

Embodiments of the inventive nanocomposite radiative film may be thermal annealed at a temperature of between 800-950° C. in an atmosphere of air, argon, or a vacuum for a period of time of between 1-10 hours.

### EXAMPLES

The following examples are intended to further illustrate the aspects of the invention.

### Example 1

The target (a disk of diameter of 50 mm and thickness of 6 mm) was prepared by hot pressing and subsequent high-temperature annealing in a vacuum. The composition of the target (composition 1) is in mole %: MoSi₂—70; SiC—30. The substrate, a polished ceramic plate was placed in the vacuum chamber at a distance of 50 mm from the magnetron target. The vacuum chamber was pumped down to a pressure of 1·10⁻³ Pa. Ar gas was filled in the chamber to a pressure of 1·10⁻¹ Pa. Sputtering was carried out with the following magnetron parameters: current—0.3 A; voltage—480V. The thickness of the film was 0.5 micron and the sheet resistance was 30 Ohm/□. The emissivity in the range 2-20 microns was 0.8.

### Example 2

A target with the following composition in mole %: MoSi₂—25; SiC—75. The chamber is filled with Ar gas to a pressure of 1·10⁻¹ Pa. Sputtering is carried out with the following magnetron parameters: current—0.3 A; voltage—500V. The thickness of the film is 0.5 micron and the sheet resistance is 80 Ohm/□. The emissivity in the wavelength of 2-20 microns is 0.8.

### Example 3

A target with the following composition in mole %: MoSi₂—34; SiC—46; SiO₂—20. The chamber is filled with Ar gas to a pressure of 1·10⁻¹ Pa. Sputtering is carried out with the following magnetron parameters: current—0.3 A; voltage—490V. The thickness of the film is 0.5 micron and sheet resistance 50 Ohm/□. The emissivity in the wavelength range of 2-20 micron is 0.79.

### Example 4

A target with the following composition in mole %: MoSi₂—46; SiC—54. Oxygen is filled in the chamber to a pressure of 7·10⁻³ Pa, and then Ar to a pressure of 1·10⁻¹ Pa. Sputtering is carried out with the following magnetron parameters: current—0.3 A; voltage—500V. The thickness of the film is 0.5 microns and sheet resistance 100 Ohm/□. The emissivity in the wavelength range 2-20 microns is 0.8.

### Example 5

A target with the following composition in mole %: MoSi₂—33, SiC—53, HfB₂—14. The chamber is filled with Ar gas to a pressure of 1·10⁻¹ Pa. Sputtering is carried out with the following magnetron parameters: current—0.3 A, pressure—440. The thickness of the film is 0.5 micron and the sheet resistance is 60 Ohm/□. The emissivity in the wavelength of 2-20 microns is 0.8.

### Example 6

A target with the following composition in mole %: MoSi₂—29, SiC—60, TiC—11. The chamber is filled with Ar gas to a pressure of 1.10⁻¹ Pa. Sputtering is carried out with the following magnetron parameters: current—0.3 A, pressure—440. The thickness of the film is 0.4 micron and the sheet resistance is 70 Ohm/□. The emissivity in the wavelength of 2-20 microns is 0.8.

Any patents or publications mentioned in this specification are herein incorporated by reference to the same extent as if each individual publication was specifically and individually indicated to be incorporated by reference. The foregoing description is illustrative of particular embodiments of the invention, but is not meant to be a limitation upon the practice thereof.

1. A thin-film radiative structure, comprising:
a substrate; and
a nanocomposite radiative film deposited on and supported by the substrate, the nanocomposite radiative film including:
a mix of dispersed phases formed by elements selected from the group consisting of: Mo, Si, C, and O that exist in the following percentage terms: Mo from 10 to 20 atomic %, Si from 15 to 30 atomic %, C from 15 to 60 atomic %, O from 0 to 20 atomic %, and
at least one element selected from the group consisting of: Ti, Zr, Hf, Cr, Si, Al, and B in percentage terms of 0 to 30 atomic %.

2. The thin-film radiative structure of claim 1, wherein the nanocomposite radiative film structure includes dispersed phases with domain size in a range of 2-100 nm.

3. The thin-film radiative structure of claim 1, wherein the nanocomposite radiative film structure includes dispersed phases with domain size in a range of 2-10 nm.

4. The thin-film radiative structure of claim 1, wherein an emissivity is not less than 0.7 for wavelengths 2-20 μm at a temperature above 500° C.

5. The thin-film radiative structure of claim 1, wherein the nanocomposite radiative film has a sheet resistance of between 10 and 150 Ohm/sq.

6. The thin-film radiative structure of claim 1, wherein the substrate is a low stress membrane in a range of 50-150 MPa.

7. The thin-film radiative structure of claim 1, wherein the substrate is a membrane with low tensile or compressive stress of 50-150 MPa.

8. The thin-film radiative structure of claim 1, wherein the substrate is made of silicon nitride.

9. The thin-film radiative structure of claim 1, wherein the substrate is a multilayer structure consisting of alternating layers of silicon nitride and silicon oxide.

10. The thin-film radiative structure of claim 9, wherein the silicon nitride and silicon oxide films each have an individual thickness in the range of 0.05-1.0 microns.

11. The thin-film radiative structure of claim 1, wherein the substrate is ceramic.

12. The thin-film radiative structure of claim 1, wherein the nanocomposite radiative film has a thickness of 0.05-1.0 μm.

13. An infra-red thermal emitter, comprising:
a thin-film radiative structure, the thin-film radiative structure including:
a substrate, and
a nanocomposite radiative film deposited on and supported by the substrate, wherein the nanocomposite radiative film is a thermoresistive element in the infra-red thermal emitter and includes:
a mix of dispersed phases formed by elements selected from the group consisting of: Mo, Si, C, and O that exist in the following percentage terms: Mo from 10 to 20 atomic %, Si from 15 to 30 atomic %, C from 15 to 60 atomic %, O from 0 to 20 atomic %, and
at least one element selected from the group consisting of: Ti, Zr, Hf, Cr, Si, Al, and B in percentage terms of 0 to 30 atomic %; and
an electric current source for heating the nanocomposite radiative film by passing an electric current through the nanocomposite radiative film.

14. An infra-red heater, comprising:
a thin-film radiative structure, the thin-film radiative structure including:
a substrate, and
a nanocomposite radiative film deposited on and supported by the substrate, wherein the nanocomposite radiative film is a thermoresistive element in the infra-red thermal heater and includes:
a mix of dispersed phases formed by elements selected from the group consisting of: Mo, Si, C, and O that exist in the following percentage terms: Mo from 10 to 20 atomic %, Si from 15 to 30 atomic %, C from 15 to 60 atomic %, O from 0 to 20 atomic %, and
at least one element selected from the group consisting of: Ti, Zr, Hf, Cr, Si, Al, and B in percentage terms of 0 to 30 atomic %; and
an electric current source for heating the nanocomposite radiative film by passing an electric current through the nanocomposite radiative film.

15. The thin-film radiative structure of claim 1, wherein the nanocomposite radiative film is used in nondispersive infrared sensors (NDIR), photo-acoustic gas sensors, or infrared signaling devices as a thermo-resistor, the thermo-resistor heated by an electric current.

16. A method of fabricating a thin film, the method comprising:
sputtering with a vacuum magnetron a target comprising a mixture of MoSi₂+X₁SiC, where X₁ is a mole percent of SiC, and 85%>X₁>10%, in an atmosphere of mixed argon plus oxygen gases with a partial pressure of the oxygen from 0 to 1·10⁻² Pa; and
forming on a substrate a nanocomposite radiative film, the nanocomposite radiative film including:
a mix of dispersed phases formed by elements selected from a first group consisting of: Mo, Si, C, and O that exist in the following percentage terms: Mo from 10 to 20 atomic %, Si from 15 to 30 atomic %, C from 15 to 60 atomic %, O from 0 to 20 atomic %, and
at least one element selected from a second group consisting of: Ti, Zr, Hf, Cr, Si, Al, and B in percentage terms of 0 to 30 atomic %.

17. A method of fabricating a thin film, the method comprising:
sputtering with a vacuum magnetron a target comprising a mixture of MoSi₂+X₂SiC+Y, where X₂ is a mole percent of SiC, and 85%>X₂>10%, and where Y is a mole percent of an oxide, 30%>Y>0% in an atmosphere of argon; and
forming on a substrate a nanocomposite radiative film, the nanocomposite radiative film including:
a mix of finely dispersed phases formed by elements selected from the group consisting of: Mo, Si, C, and O that exist in the following percentage terms: Mo from 10 to 20 atomic %, Si from 15 to 30 atomic %, C from 15 to 60 atomic %, O from 0 to 20 atomic %, and
at least one element selected from the group consisting of: Ti, Zr, Hf, Cr, Si, Al, and B in percentage terms of 0 to 30 atomic %.

18. The method of claim 17, wherein the oxide is selected from the group consisting of: Si0₂, Ti0₂, Zr0₂, A1₂0₃, B₂0₃, or a combination thereof.

19. A method of fabricating a thin film, the method comprising:
sputtering with a vacuum magnetron a target consisting of MoSi₂+X₃SiC+Z, where X₃ is a mole percent of SiC, and 100%>X₃>0%, and where Z is a mole percent of a boride, 60%>Z>0% in an atmosphere of argon; and
forming on a substrate a nanocomposite radiative film, the nanocomposite radiative film including:
a mix of dispersed phases formed by elements selected from a first group consisting of: Mo, Si, C, and O that exist in the following percentage terms: Mo from 10 to 20 atomic %, Si from 15 to 30 atomic %, C from 15 to 60 atomic %, O from 0 to 20 atomic %, and
at least one element selected from a second group consisting of: Ti, Zr, Hf, Cr, Si, Al, and B in percentage terms of 0 to 30 atomic %.

20. The method of claim 19, wherein the boride is selected from the group consisting of: TiB₂, ZrB₂, HfB₂, CrB₂, SiB₄, SiB₆, CB₂, or a combination thereof.

21. A method of fabricating a thin film, the method comprising:
sputtering with a vacuum magnetron a target consisting of MoSi2+X₄SiC+W, where X₄ is a mole percent of SiC, and 100%>X₄>0%, and where W is a weight percent of carbide metals, 60%>W>0% in an atmosphere of argon; and
forming on a substrate a nanocomposite radiative film, the nanocomposite radiative film including:
a mix of dispersed phases formed by elements selected from a first group consisting of: Mo, Si, C, and O that exist in the following percentage terms: Mo from 10 to 20 atomic %, Si from 15 to 30 atomic %, C from 15 to 60 atomic %, O from 0 to 20 atomic %, and
at least one element selected from a second group consisting of: Ti, Zr, Hf, Cr, Si, Al, and B in percentage terms of 0 to 30 atomic %.

22. The method of claim 21, wherein the carbide metals are selected from the following chemical compounds: TiC, HfC, ZrC, or a combination thereof.

23. The method of claim 21, further comprising applying a substrate electrical bias in the range of 0-400 V.

24. The method of claim 23, wherein the bias is a radio frequency.

25. The method of claim 24, wherein the radio frequency ranges between 100 KHz-13.6 MHz.

26. The method of claim 16, further comprising thermal annealing in one of: air, argon, or a vacuum of the deposited thin-film on said substrate at a temperature of between 800-950° C.

27. The method of claim 26, further comprising thermal annealing for a period of time of between 1-10 hours.
